(19) United States
(12) Patent Application Publication
(10) Pub. No.: US 2005/0056696 A1
(43) Pub. Date: Mar. 17, 2005

(54) Automated ticket collection system and method of collecting ticket information

(75) Inventors: Julie Green, Langhorne, PA (US); Lawrence Chickola, Yardley, PA (US); E. Steven Emanuel, Cedar Run, NJ (US); Alan Cruickshank, Edison, NJ (US)

Correspondence Address: STUART RUDOLER LLC;ATTN: DOCKET CLERK, 2 BALA PLAZA, SUTIE 300, BALA CYNWYD, PA, 19004, US

(73) Assignee: Lawrence Chickola

(21) Appl. No.: 10/971,348

(22) Filed: Oct. 22, 2004

Related U.S. Application Data
(62) Division of application No. 09/565,160, filed on May 3, 2000.
(60) Provisional application No. 60/162,706, filed on Oct. 29, 1999.

(51) Int. Cl. G06K 5/00; G07B 15/02

(52) U.S. Cl. 235/384; 235/382

(57) ABSTRACT

A system and method for collecting ticket data from mass transportation vehicles in which conductors on each vehicle collect tickets, scan in the ticket information into readers, and the readers on each vehicle transmit the ticket information back to a central computer. In some embodiments the central computer can also transmit data, such as expected passenger lists, to the readers.

### CROSS-REFENCE TO RELATED APPLICATION

This application is a divisional of U.S. application Ser. No. 09/565,160 filed May 3, 2000, incorporated herein by reference, which claims the benefit of U.S. Provisional Application No. 60/162,706, filed Oct. 29, 1999.

### BACKGROUND OF INVENTION

This invention relates generally to data collection systems, and more specifically to a ticket collection system for passenger mass transportation system, in the present embodiment a passenger railroad system. The invention provides for a device to assist conductors in collecting and reading passenger tickets, converting the ticket data into an electronic format, and transferring the data from the train to a central computer, where the information is made available to the railroad company for use in selling tickets and maintaining lists of passengers on trains. The invention is capable of receiving such data from multiple trains operating simultaneously.

Currently, in modern passenger rail systems, passengers carry paper tickets with them onto trains. Conductors walk through the trains after every stop and collect tickets from new passengers who have boarded the train. Many passengers purchase their tickets prior to boarding a train, either at a train station, from the train company or through a travel agent. If the passenger does not have a ticket, the conductor manually writes out or punches a ticket and sells it for cash or by credit card to the passenger. After collecting tickets from each passenger, the conductor generally issues each passenger a paper seat check that indicates the destination of that passenger. The conductor may mark the seat check by manually punching holes in it. A need exists to provide for an automated ticket collection system which reduces the manual labor involved in selling, collecting and processing tickets and generating seat checks on board a train.

One problem with the current manual process is that the train company does not have timely information about the number or identity of passengers on the train until the trip is over, the conductor turns in the tickets, and the tickets are counted and read. Even though some or all of the seats on certain trains are reserved, the train company only knows which passengers plan to be on which trains, but does not know which passengers or how many actually board each train. Also, the train company does not know how many seats on each train have actually been used, since the tickets are collected after the train leaves the station. Because the train can spend many hours between train stations, and in some cases only stopping at a given station for several minutes, many times there is no opportunity to find out how many seats are taken on a train until the train reaches its final destination, several days after its departure. This prevents timely information from being available to the train reservation system to sell empty seats for trains en route. Similarly, because the conductor on the train is isolated from the train reservation system, he or she is unaware of cancellations of seats, particularly upgraded seats (such as business class or first class), which he or she might be able to sell to passengers already on the train.

The problems described arise in part because trains typically do not have a pre-boarding stage, as is frequently found on airlines. While it would be possible to institute a pre-boarding stage, this is generally not desirable since one of the competitive advantages trains have over other forms of transportation is the quick boarding process. Typically, customers expect to arrive at the station only minutes before the train arrives, as compared with airlines where a minimum of an hour pre-arrival is often required. Also, many train stations are unmanned, making pre-boarding impractical. A system that could communicate tickets, reservation sales and seat class between trains and the train company's central computer while the train is en route is therefore desirable.

Once tickets are collected by the conductors on the trains, the conductors take the tickets back to their work area on the train and sort and count the tickets manually. The conductor retains the tickets until the end of the trip and then turns them over to an administrative office. These tickets are then manually reviewed by data processing personnel, who enter in the ticket numbers into the train company's computer system. It is not until this process is completed that the train company knows that a ticket that was previously sold has been used, or which passengers have traveled on which train. A system that could immediately recognize ticket number and enter them into the train company's computer systems without human intervention is desirable. This would give the conductors more time to attend to passenger needs, reduce the number of administrative and data entry personnel needed off the train, and increase the accuracy of the data collected.

As previously discussed, conductors sometimes sell tickets on the train by credit card. However, because the train cannot communicate with the credit card issuer, the conductor has no means of knowing whether a credit card is valid or not. This may result in the conductor selling tickets to passengers who give credit cards that have been stolen or revoked or have exceeded their credit limit. Because of this greater risk, credit card issuers typically charge higher fees for use of credit cards on trains due to the inability to detect fraud. In addition, due to delays in manual processing of credit card transactions, there is a substantial delay in receiving the funds for on-board credit card sales. A need therefore also exists for a fare collection system that can validate credit card information in a timely manner.

As the economy moves increasingly towards electronic commerce, smart cards are becoming more prevalent. Smart cards are credit card size devices with embedded integrated circuits capable of storing data. Smart cards can store electronic cash or, in the context of a train system, they can store prepaid trips and passenger data. A need, therefore, exists for a fare collection system capable of processing smart cards in lieu of paper tickets.

Another problem with the current system is that no list of passengers, typically called a passenger manifest, can be generated for any train until after a train has completed its trip. Aside from the previously discussed loss of revenue, this creates a safety hazard. In the event of a train accident, the train company is unable to determine the exact number and identity of passengers on the train for rescue workers to look for. It also makes it difficult in times of crisis for the train company to provide timely and accurate information to families of persons who may be on a train. A need therefore also exists for a system which can transfer information about passengers from the train, while it is en route, and use this information to generate a passenger manifest.

### BRIEF DESCRIPTION OF THE INVENTION

The present invention provides a complete ticket collection system that is capable of reading paper or electronic tickets on a moving train, converting the ticket information to electronic data and transferring this information to a central computer for processing. A train conductor collects tickets from passengers, sells tickets and generates boarding passes using a computerized portable reader that may include a printer. The reader is capable of scanning ticket numbers from paper tickets as well as reading electronic smart cards. A vehicle computer on board each train collects data via wireless communication from the various readers being used by the multiple conductors on the train. The vehicle computer transfers this data off the train via wireless communication link to a central computer, either directly, via wireless telephone communication link, or via a network of local computers located a certain train stations. Once the information is transferred to the central computer, ticket data may be aggregated in a data base. This database may be used to update the train company's ticket sales and reservations computer. The database of ticket numbers, each identified to a specific train, may also be used to generate a passenger list for each train.

### BRIEF DESCRIPTION OF THE DRAWINGS

FIG. 1 is a view showing the major components of the invention.

FIG. 2 is a view of the reader, including a printer.

FIG. 3 is a view of one embodiment of the invention in which the readers communicate directly with the central computer.

FIG. 4 is a view of one embodiment of the invention in which the readers communicate with a vehicle computer, which in turn communicate directly with the central computer.

FIG. 5 is a view of one embodiment of the invention in which the vehicle computers communicate with the central computer via satellite.

FIG. 6 is a view of one embodiment of the invention in which the vehicle computers communicate with local computers at fixed locations along the path of the vehicle, and in which the local computers communicate with the central computer via a wide area network.

FIG. 7 is a view of one embodiment of the invention in which it is being used to preboard passengers.

### DETAILED DESCRIPTION OF THE INVENTION

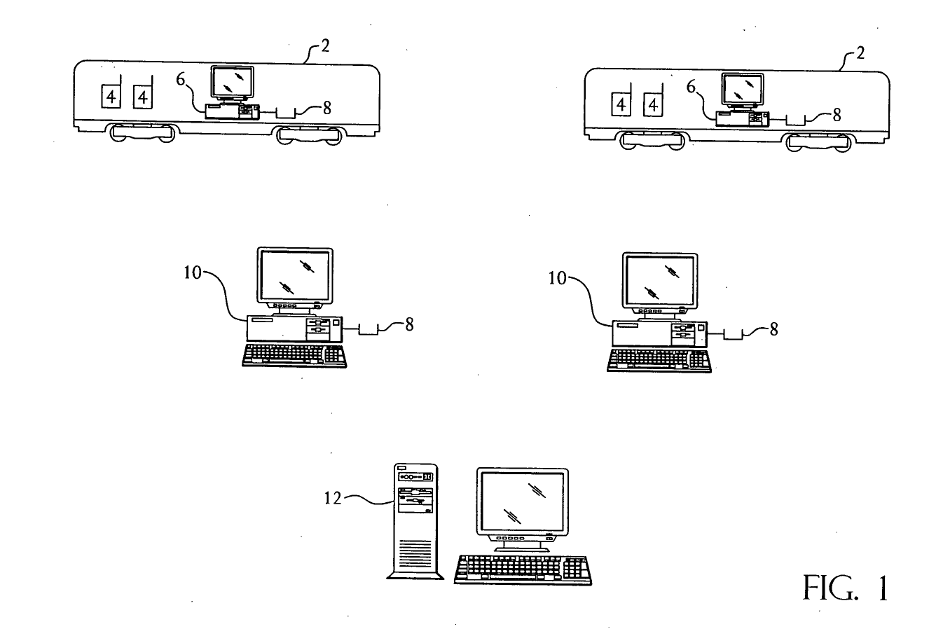

A block diagram of the fare collection system of the present invention is shown in FIG. 1. The system is designed to collect tickets from passengers on vehicles 2 and communicate ticket data to a central computer 12 accessible by the operator of the system. In the embodiment of the invention described herein, the vehicle is a train, but the invention can be equally well implemented on other passenger mass transportation vehicles such as buses, airplanes or ships. Likewise, the data need not be ticket information, but could represent other types of information such as food, credit card, inventory, or passenger information. Further, the ticket, as described herein, could be any media able to contain data.

Typically operators of passenger trains operate large fleets of trains. Prior to boarding trains 2 passengers purchase tickets. In the present embodiment, issuance of tickets is controlled by a central reservation computer which creates a database of unique numbers for each ticket as well as the name of the passenger, origin and destination of the passenger, seat class, and if reserved, the expected date and time of travel. On each train 2, a conductor uses a reader 4 to assist in the collection of tickets.

Preferably the reader 4 should be capable of reading and automatically verifying a number of different types of tickets. Some tickets may be printed with ticket numbers or coded in bar codes. Other tickets maybe have computer readable numbers printed on them. Still others may have tickets numbers magnetically encoded. Tickets may also take the form of electronic smart cards where a certain number of trips are prepaid for on the card and the reader deducts the trips from the smart card.

In one embodiment, the reader 4 is also capable of selling tickets to passengers who have not previously purchased their tickets, and of upgrading passengers who have existing tickets. The reader 4 may also be used to accept credit or debit cards. Any type of media capable of storing data can be used as a ticket. Tickets could take the form of a hologram (optical data), magnetic card, or smart card. In one embodiment, the ticket could be a passive device known as a RF tag. When the reader 4 is held in close proximity to such a tag, the reader 4 bombards the tag with RF energy. This causes a passive device within the tag to transmit back a unique signal to the reader 4. The advantage of such a tag is that it requires no batteries, since it uses the RF energy from the reader 4 to transmit its signal. Such RF tags are well known in the art and are in common use at gas stations, parking lots and in security systems. In some embodiments of the invention the reader 4 also includes a printer 18 so that the conductor can print seat checks and sales receipts for passengers. In some embodiments, the reader 4 may store the credit card information and an image of the signature for later processing. The reader 4 may also store in its memory, a list of bad credit card numbers that should not be accepted for payment.

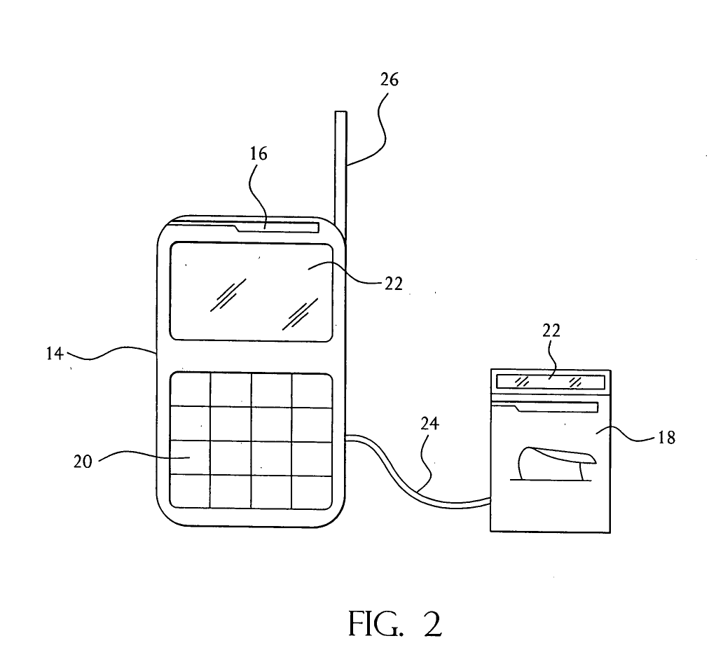

FIG. 2 shows a typical portable reader 4 that would be used by a conductor. The base unit is a hand held unit 14 carried by the conductor. The reader 4 includes a scanner, used with bar coded tickets, for reading ticket numbers from tickets. In the present embodiment, the scanner is a small diode laser that reflects light off of the ticket and is received by an optical sensor built into the unit. An optical scanner with optical character recognition can also be used to read character-based ticket numbers. A laser capable of reading holograms or an RF transmitter/receiver may also be used to read ticket data. The reader may also have a keyboard 20 for entering numbers or letters, a display 22, and a slot 16 into which a credit card can be inserted and read. In one embodiment the hand held unit 14 is connected to a printer 18 which a conductor wears on his belt. The reader 18 may also include, a smart card reader 22, in the present embodiment built into the printer. As shown in FIG. 2, the hand held unit 14 is attached to the printer 18 via a cable 24, however, they could communicate via infrared or radio frequency signal as well. Alternatively the components of the reader 4 may be combined into one hand-held unit which could be either carried by hand or on the hip of the conductor. The reader 4 may also contain a signal transmitter and antenna 26 so that it can communicate wirelessly. Instead of or in addition to a wireless transmitter, it may communicate using an infrared signal, or a physical electrical connection. It will be obvious to those skilled in the art that the particular embodiment of the reader 4 is not critical to this invention and that many embodiments, some of which are well known in the prior art, may be used.

For trains where tickets are collected by conductors, the reader must be small and portable. In the incidence of a bus, where tickets are often collected by the driver, the reader may be mounted next to the driver and need not be portable.

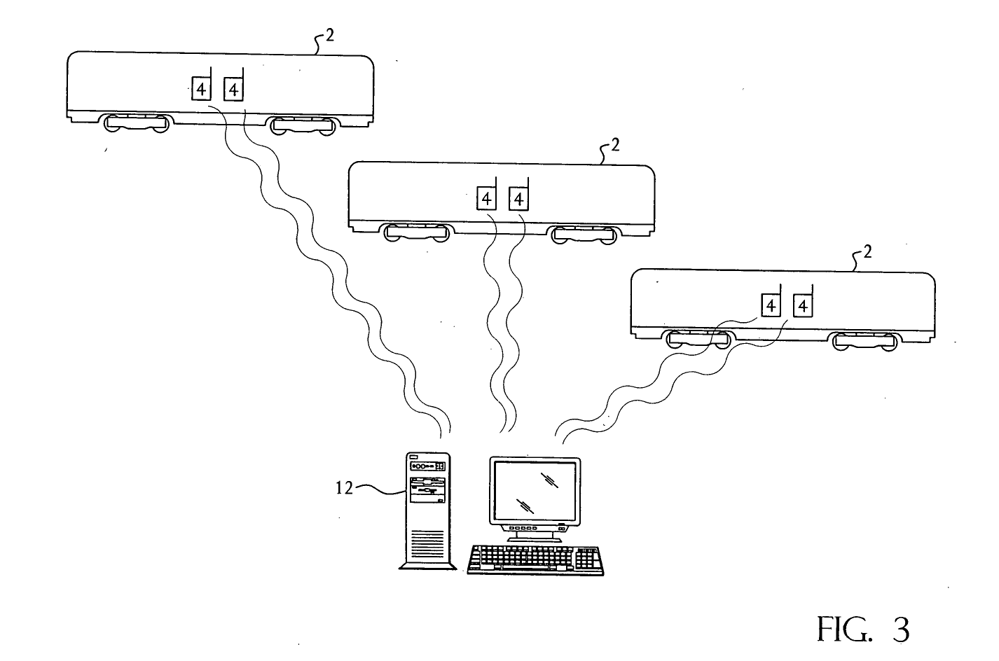

In the simplest configuration shown in FIG. 3, the various readers 4 communicate directly with the central computer 12 which collects the data from on-board the various trains 2 and creates a data base of collected ticket numbers. The communication link can either be continuous or established on a periodic basis.

In one embodiment, as shown in FIG. 1, the system includes a vehicle computer on each train and local computers 10 at certain stations. The vehicle computer 6 is a computer dedicated to a particular train 2 that is capable of receiving data from one or more readers 4. In one embodiment, the reader 4 communicates with the vehicle computer 6 through a docking station 8. When the reader 4 is inserted into the docking station 8 data is transferred via cable from the docking station 8 to the vehicle computer 6. This embodiment requires conductors to place the reader 4 in a docking station 8 after the tickets are collected. Multiple docking stations can be provided for trains 2 with multiple readers 4. In the preferred embodiment, the reader 4 communicates with the vehicle computer 6 wirelessly. The reader 4 may communicate with the vehicle computer 6 continuously, after each transaction, after a certain number of transactions, or after a set amount of time. The vehicle computer 6 aggregates data from the multiple readers 4 on the train 2 and prepares the data for transmission off the train 2.

Multiple solutions are available to transfer the data off of the train 2 from the vehicle computer 6. In one simple configuration, the vehicle computer 6 simply writes to a removable storage medium, such as a magnetic or optical disk, all of the data collected from the ticket reading devices 4. This removable storage medium can then be inserted into a local computer 10 available at various stations along the train 2 route and at train 2 trip ends. Alternatively, a reader 4 could be used to transfer the data. In this configuration, the vehicle computer 6 would transfer, at the end of a trip, the necessary data to a reader 4, either wirelessly of through a docking station 8, and then the reader 4 can be carried off the train 2 by a conductor. The reader 4 then transfers the data to a local computer 10 in the station either wirelessly or through a docking station 8 (attached to the local computer 10). In the preferred embodiment the vehicle computer 6 senses when it comes within transmission range of a local computer 10 and transmits the date wirelessly to that local computer 10. This data transfer may be accomplished through the means of a wireless local area network at the station. Such networks are readily available and well known to those skilled in the art. One advantage of wireless transmission is that the data can be transferred even if the train 2 only stops for a few minutes, or even while the train 2 is in motion.

As stated, it is preferable that the vehicle computer 6 sense that it is within transmission range of a station and automatically transfer the data. One technique to accomplish this, known as polling, is for the vehicle computer 6 to send a test transmission at set intervals, such as once per minute. If a local computer 10 is in transmission range and receives the test signal, it can send a reply transmission, thus alerting the vehicle computer 6 to transmit data. Another technique is for the local computer 10 to continuously transmit a beacon signal. When the vehicle computer 6 receives this beacon signal it knows it is in transmission range and begins transmitting data. Other techniques are well known in the art and incorporated within the scope of this invention. Alternatively, instead of automatic data transmission, a train conductor can instruct the vehicle computer 6 to transmit data when the train 2 pulls into a station.

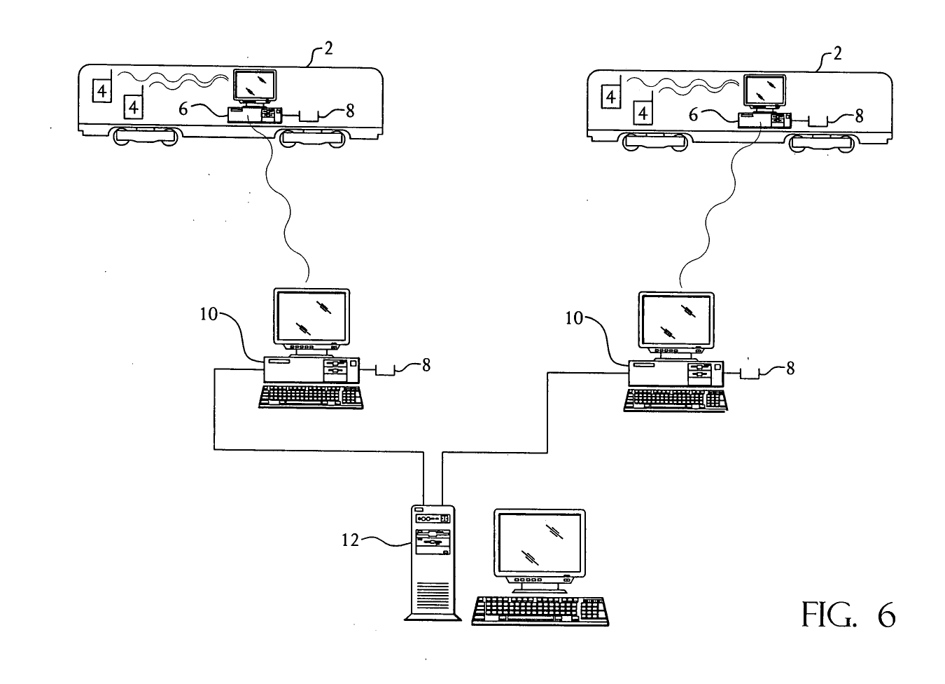

The local computers 10 are designed to be local conduits to the train company's central computer 12. Local computers 10 are distributed at strategic stations throughout the transportation system. As the local computers 10 receive data from some or all of the vehicle computers 6 on board various trains 2, they store this information and transfer it to the central computer 12 over a wide area network or through traditional dial-up telephone modem, as shown in FIG. 6. Alternatively, the local computers 10 may communicate with the central computer 12 through wireless transmission such as satellite. The central computer 12 aggregates data from the various local computers 10 throughout the system and creates a data base of ticket numbers actually collected on each train. With this data base, train personnel are able to determine how many people are on each train and how many seats of which class are available for sale. By accessing this data base, sales clerks and ticket agents, and even customers, have better information about available seats.

At this point the central computer 12 can also create a passenger list for each train in the system. If the trains reservation system takes the name of each customer as it sells a ticket, then by correlating the ticket number to the purchaser, a list of each person on the train can be generated. In addition, for tickets sold by credit card, the credit card information can be accessed to identify a ticket holder. Of course smart card tickets would electronically identify card holder names. The passengers list may not be perfect, since purchasers of tickets can give the tickets to another person, but there will be at least a count of the number of passengers on each train 2.

While in the system as described, the data medium contains unique identifying information such as ticket number, in some applications this is not necessary. It may be desirable for the ticket simply to identify that a unit fare has been paid, or the destination of the traveler. In such case, the data transmitted may simply be a count of the number of tickets collected. A passenger daily commuter train or bus system might use the invention in this mode.

The invention as described heretofore, is limited in that information can only be received from a train 2 when it is near a station where there is a local computer 10. Thus, in situations where trains 2 must travel long distances between stations with local computers 10, the system operator lacks information about the number of seats available as well as the number of people on each train 2. In the preferred embodiment the vehicle computer 6 is capable of communicating with the central computer 12 even while it is traveling between stations. This can be accomplished through the addition of a wireless modem to the vehicle computer 6. These modems, commonly available for transmission of data over cellular telephone networks deployed throughout the United States, allow the wireless transmission of data from the vehicle computer 6 to the central computers 12. Alternatively, as shown in FIG. 3, using a cellular modem, a reader 4 could transmit directly to the central computer 12 by bypassing the vehicle computer 6. Readers with such communication capability built in are now available for mobile access to the Internet, and could be easily adopted to the present invention. Indeed, in areas where wireless access to the Internet is available, the Internet can be used as a transmission medium to the central computer 12. From the point of view of the central computer 12, transmissions over the digital wireless cellular phone network are received the same way an ordinary data transmission through telephone lines would be received. The handling of the phone data transmission may be offloaded from the central computer 12 to one or more dedicated communication computers, which handle the data transmissions from the vehicle computers 6 and transfer the data to the central computer 12.

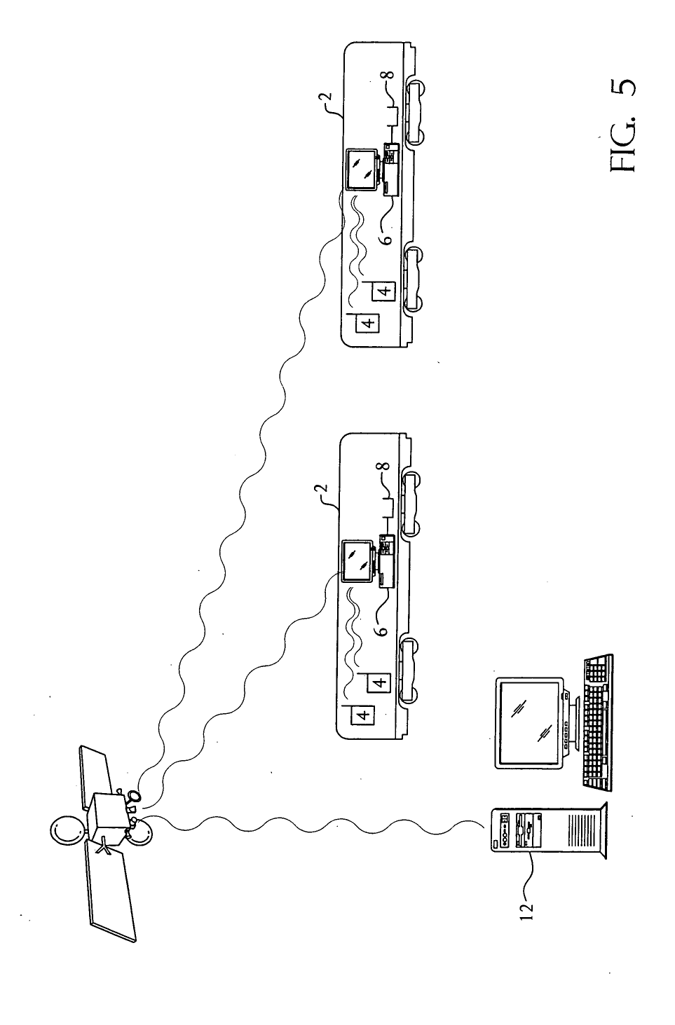

In some circumstances, the trains 2 may travel and pick up passengers in areas where cellular telephone service is not currently available. In such case as, as shown in FIG. 5, vehicle computers 6 can be equipped with data modems capable of transmitting to satellite networks 26 that are capable of providing wireless data telephone coverage throughout the United States. Alternatively, direct satellite transmission could be used.

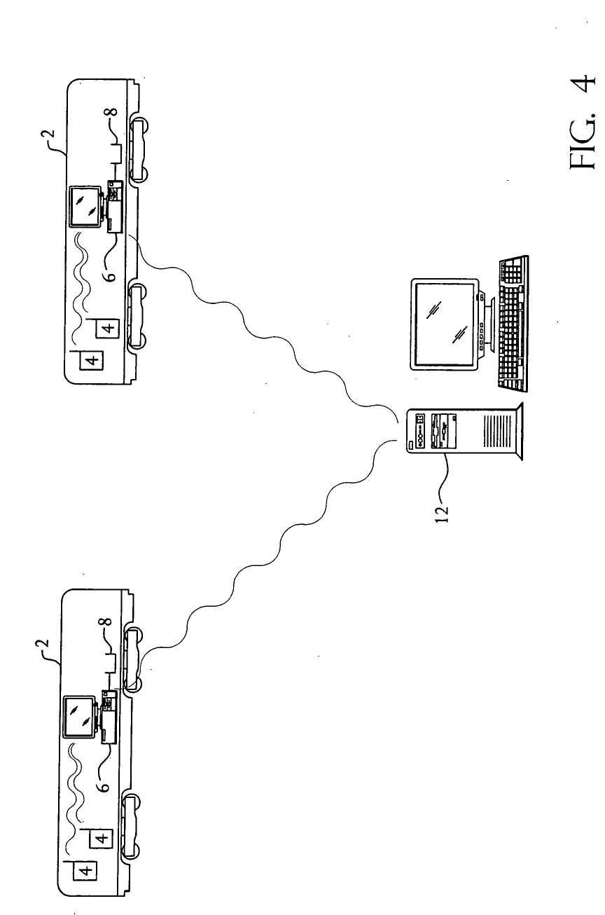

It will be obvious to those skilled in the art that the configuration described herein is subject to many variations, and the various pieces of the system may be combined or eliminated, depending on the communication path selected. For example, in one possible configuration shown in FIG. 3, the vehicle computer 6 and station computer 10 may be eliminated and the reader 4 can be equipped with a modem so that it can communicate over a digital wireless network directly with the central computer 12. In an alternative configuration, the reader 4 can store all data until the end of the trip, at which point they dock with a local computer 10 in order to transfer data to the local computers 10 and from there to the central computer 12. Yet another alternative, as shown in FIG. 4, is to eliminate the local computers 10 and have the vehicle computers 6 communicate directly with the central computer 12. The invention claimed is meant to encompass all such embodiments and variations thereto.

The system as described contains a number of data links formed by communication means. The important feature of these links is that they create a communication path from the readers 4 to the central computer 12. Any technology for each of these communication means would be suitable and the descriptions herein are not meant to limit the technology of communication. Examples of currently available communication means are RF, infrared, laser, microwave, optical, analog cellular telephone, digital wireless telephone, wire-based telephone, physical electrical connection, fiber optics, direct satellite, telephone-based satellite, local area computer networks (hard wired and wireless), wide area computer networks (including the Internet and intranets). Other available communication means, including technologies hereafter developed, are incorporated within the scope of this invention.

The communication path developed in the claimed invention also provides the opportunity for additional beneficial functions, particularly if it is designed for bidirectional communication. For instance, the central computer 12 can download a current list of all outstanding ticket numbers through the local computer 10 to the vehicle computer 6, or alternatively, tickets that have been issued within the last week. If this information is also provided with the names of the passengers who purchased the ticket numbers, then once the conductor scans in the ticket number with the reader 4, it can provide him with the name of the passenger. A similar functionality can be provided for bad credit card numbers.

Alternatively, credit card sales can be transmitted from the train 2 at one station. The central computer 12 can validate the sales while the train is en route and transmit a list of bad sales at the next station. This would allow a train conductor to know that a credit card sale was bad while the passenger is likely to still be on the train 2. Alternatively, the reader 4 or the vehicle computer 6, could directly communicate and clear credit card sales with the credit card company in real time.

Another possible function could be to provide real time information with respect to sales at locations along the train's 2 route. This would be useful in a situation where a passenger wishes to upgrade to a first class seat, but the conductor believes he is required to hold a certain number of reserved seats for stations further on in the trip. If any of those reserved seats have been released in the interim, the central computer 12 can update the conductor's information periodically, either directly to the reader 4 or through the vehicle computer 6, so that he is able to sell the seat.

In still another use of the communication path disclosed herein, a Global Positioning Satellite receiver can be connected to the vehicle computer 6. The vehicle computer 6 can then transmit on a periodic basis the train's 2 position while en route through the wireless data modem previously discussed.

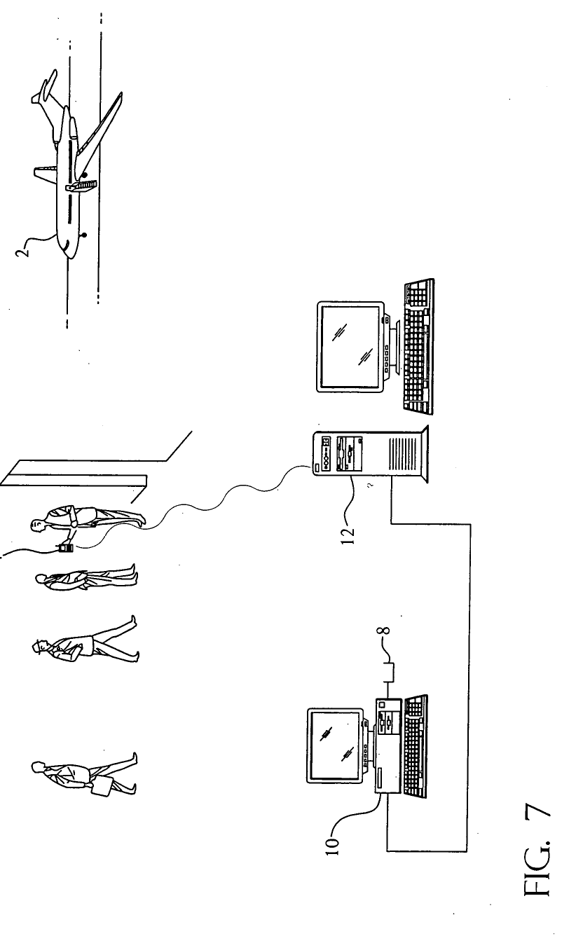

The current invention can also be used to accomplish preboarding of passengers at a station as shown in FIG. 7. In this mode an attendant would collect tickets using the reader 4 as passengers boarded the train 2. Then ticket data can then be transmitted, either wirelessly or through a docking station 8, to a local computer 10, and from there on to the central computer 12. A printer can also be incorporated to print receipts or tickets. In this mode, an attendant could also sell tickets to those passengers who have not pre-purchased their tickets. Clearly, as with the other embodiments of the invention, a local computer 10 is not required, a communication could be from the reader 4 directly to the central computer 12 through any of the previously mentioned communication means. Similarly, the reader can be stationary or portable.

It should also be recognized that the invention as described is very robust in that it provides multiple communication paths. If the transmitter in a reader 4 fails, the reader 4 may dock with the vehicle computer 6. If a local computer 10 fails, the vehicle computer 6 may store the data until the train reaches the next local computer 10, or the vehicle computer 6 may transmit the data directly to the central computer 12.

It is understood that the invention is not limited to the disclosed embodiments, but on the contrary, is intended to cover various modifications and equivalent arrangements included within the spirit and scope of the appended claims. Without further elaboration, the foregoing will so fully illustrate the invention, that others may by current or future knowledge, readily adapt the same for use under the various conditions of service.

1. A method for collecting data from mass transportation vehicles comprising:
issuing a plurality media each with unique identifier data;
placing the media on a plurality of vehicles;
reading the data from the media on the vehicles;
transmitting the data off each vehicle to a central computer;
aggregating the data into a central data base.

2. The method of collecting data described in claim 1 wherein the step of transmitting the data to a central computer is further comprised of:
transmitting the data to a vehicle computer on each vehicle;
transmitting the data from each vehicle computer, off each vehicle, to the central computer.

3. The method of collecting data described in claim 1 wherein the step of transmitting the data to a central computer is further comprised of:
transmitting the data off each vehicle to a local computer;
transmitting the data from each local computer to the central computer;

4. The method of collecting data described in claim 1 wherein the step of transmitting the data to a central computer is further comprised of:
transmitting the data to a vehicle computer on each vehicle;
transmitting the data from each vehicle computer, off each vehicle, to a local computer;
transmitting the data from each local computer to the central computer;

5. The method of collecting data described in claim 1 further comprising:
transmitting data from the central computer to the vehicle.

6. The method of collecting data described in claim 1 wherein the step of transmitting data off the vehicle to central computer is performed while the train is in motion.

7. A method for collecting ticket data and generating passenger lists from mass transportation vehicles comprising:
creating a first data base of unique ticket numbers;
issuing a plurality of media, each containing a unique ticket number to passengers;
entering the name of each passenger into the first data base in a manner so that the passenger name is correlated to the ticket number contained in the media issued to that passenger;
boarding the passengers onto the vehicle along with the media issued to each passenger;
reading the ticket data from the media on the vehicles;
transmitting the ticket data off each vehicle to a central computer along with a code identifying the vehicle from which the data is transmitted;
aggregating the ticket data into a second database;
comparing the first database and the second database to generate a list of the ticket numbers and passenger names for each vehicle.

8. The method of collecting data described in claim 7 wherein the step of transmitting the ticket data to a central computer is further comprised of:
transmitting the ticket data to a vehicle computer on each vehicle;
transmitting the ticket data from each vehicle computer, off each vehicle, to the central computer.

9. The method of collecting data described in claim 7 wherein the step of transmitting the ticket data to a central computer is further comprised of:
transmitting the ticket data off each vehicle to a local computer;
transmitting the ticket data from each local computer to the central computer.

10. The method of collecting data described in claim 7 wherein the step of transmitting the ticket data to a central computer is further comprised of:
transmitting the ticket data to a vehicle computer on each vehicle;
transmitting the ticket data from each vehicle computer, off each vehicle, to a local computer;
transmitting the ticket data from each local computer to the central computer.

11. The method of collecting ticket data described in claim 7 further comprising:
transmitting ticket data from the central computer to the vehicle.

12. The method of collecting data described in claim 7 wherein the step of transmitting ticket data off the vehicle to the central computer is performed while the train is in motion.

13. The method of collecting data described in claim 7 where the first database and second database are contained in a single database.

14. A method of preboarding passengers onto mass transportation vehicles comprising:
collecting media containing ticket data from each passenger prior to said passenger boarding a vehicle;
reading the ticket data from the media on the vehicles;
transmitting the ticket data to a central computer along with a code identifying the vehicle upon which the passenger is boarding;
aggregating the ticket data into a database.
